(19) United States
(12) Patent Application Publication
(10) Pub. No.: US 2026/0357776 A1
(43) Pub. Date: Nov. 12, 2026

(54) FUEL INJECTOR FOR FIRST AND SECOND FUELS, COMBUSTION ENGINE AND VEHICLE

(71) Applicant: Scania CV AB, Södertälje (SE)

(72) Inventor: Mateusz PUCILOWSKI, Järna (SE)

(73) Assignee: Scania CV AB, Södertälje (SE)

(21) Appl. No.: 19/134,836

(22) PCT Filed: Dec. 7, 2023
(86) PCT No.: PCT/SE2023/051229

§ 371 Date: Jun. 2, 2025

(30) Foreign Application Priority Data
Dec. 9, 2022 (SE) 2251439-2

(51) Int. Cl. F02M 61/18; F02D 19/06; F02M 55/00; F02M 61/10

(52) U.S. Cl. CPC F02M 61/1846; F02D 19/0694; F02M 55/008; F02M 61/10; F02M 61/1886

(57) ABSTRACT

A fuel injector is disclosed configured to inject a first and a second fuel into a combustion chamber of an internal combustion engine. The fuel injector comprises a nozzle portion provided with a number of first fuel injection holes for injecting the first fuel into the combustion chamber, wherein the first fuel injection holes are circumferentially distributed on the nozzle portion around a center axis of the nozzle portion. The nozzle portion is further provided with a second fuel injection hole for injecting the second fuel into the combustion chamber. The second fuel injection hole is configured to inject the second fuel in a main fuel injection direction substantially coinciding with the center axis of the nozzle portion. The present disclosure further relates to an internal combustion engine and a vehicle.

### CROSS-REFERENCE TO RELATED APPLICATIONS

This application is a national stage application (filed under 35 § U.S.C. 371) of PCT/SE2023/051229, filed Dec. 7, 2023 of the same title, which, in turn claims priority to Swedish Patent Application No. 2251439-2, filed on Dec. 9, 2022; the contents of each of which are hereby incorporated by reference.

### TECHNICAL FIELD

The present disclosure relates to a fuel injector configured to inject two different fuels into a combustion chamber of an internal combustion engine. The present disclosure further relates to an internal combustion engine comprising a fuel injector and a vehicle comprising an internal combustion engine.

### BACKGROUND

Internal combustion engines, such as four-stroke internal combustion engines, comprise one or more cylinders and a piston arranged in each cylinder. The pistons are connected to a crankshaft of the engine and are arranged to reciprocate within the cylinders upon rotation of the crankshaft. The engine usually further comprises one or more inlet valves and outlet valves as well as one or more fuel supply arrangements. The one or more inlet valves and outlet valves are controlled by a respective valve control arrangement usually comprising one or more camshafts rotatably connected to a crankshaft of the engine, via a belt, chain, gears, or similar. A four-stroke internal combustion engine completes four separate strokes while turning a crankshaft. A stroke refers to the full travel of the piston along the cylinder, in either direction.

The strokes are completed in the following order, inlet stroke, compression stroke, expansion stroke and exhaust stroke. During operation of a conventional four-stroke internal combustion engine, the inlet valve control arrangement controls inlet valves of a cylinder to an open state during the inlet stroke of a piston within the cylinder, to allow air, or a mixture of air and fuel, to enter the cylinder. During the compression stroke, all valves should be closed to allow compression of the air, or the mixture of the air and fuel, in the cylinder. If the engine is in a power producing state, fuel in the cylinder is ignited, usually towards the end of the compression stroke, for example by a spark plug or by compression heat in the cylinder.

The combustion of fuel within the cylinder significantly increases pressure and temperature in the cylinder. The combustion of the fuel usually continues into a significant portion of the subsequent expansion stroke. The increased pressure and temperature in the cylinder obtained by the combustion is partially converted into mechanical work supplied to the crank shaft during the expansion stroke. The expansion stroke is also usually referred to as the combustion stroke, since usually, most of the combustion takes place during the expansion stroke. In the subsequent exhaust stroke, the exhaust valve control arrangement controls exhaust valves of the cylinder to an open state to allow exhaust gases to be expelled out of the cylinder into an exhaust system of the combustion engine.

A fuel injector is a device used for supplying fuel to a combustion chamber of an internal combustion engine. Compression ignition engines, such as diesel engines, and some spark ignition engines, such as Otto engines, use a fuel injector configured to supply fuel into a combustion chamber. Gasoline engines having a fuel injector for supplying fuel into a combustion chamber are usually referred to as gasoline direct injection engines. In diesel engines, the injected fuel is ignited by compression heat, or by a glow plug. In Otto engines, the injected fuel is ignited by a spark of a spark plug.

Fuel injectors configured to inject fuel into a combustion chamber of an internal combustion engine typically comprise a nozzle with a nozzle portion protruding into the combustion chamber. The nozzle portion typically comprise a number of fuel injection holes for the injection of fuel into the combustion chamber. Moreover, the nozzle portion typically comprises a valve seat an inner surface of the nozzle portion and a needle configured to interact with the valve seat to open and close a fluid connection between a fuel cavity of the fuel injector and the number of fuel injection holes.

Some fuel injectors have been developed capable of injecting two different fuels into a combustion chamber of an internal combustion engine. An example of an engine utilizing such a fuel injector is a Bi-fuel engine configured to operate on a first fuel and a second fuel, wherein the second fuel has a lower research octane number than the first fuel.

The research octane number of a fuel indicates the fuel's ability to withstand compression in a combustion chamber without detonating. The term “detonating” in this context means an autoignition which is a type of self-ignition caused by the compression heat and pressure in a combustion chamber. The higher the octane number, the more compression the fuel can withstand before detonating/igniting. In other words, a fuel with a high research octane number has a high ability to withstand compression before detonating/igniting whereas a fuel with a low research octane number has a low ability to withstand compression before detonating/igniting.

As indicated above, in compression ignition engines, an autoignition of the fuel is wanted towards an end of the compression phase. Therefore, in compression ignition engines operating on fuels with high research octane numbers, such as natural gas or hydrogen fuel, a fuel having a lower research octane number, such as diesel, can be injected into the cylinder, wherein the combustion of the fuel with the lower research octane number ignites the fuel with the higher research octane number.

A fuel injector for injecting two different fuels normally comprises the same number of fuel injection holes for the two different fuels, wherein the fuel injection holes are arranged and oriented such that adjacent pair of fuel stream formations are obtained in the combustion chamber. In this manner, the combustion of the fuel of a fuel stream formation with the lower research octane number can ignite the fuel of a fuel stream formation with the higher research octane number.

Hydrogen fuel refers to hydrogen which can produce zero hydrocarbon emissions provided that the hydrogen is produced in a process that does not involve fossil carbon. Some compression ignition engines have been developed operating on hydrogen fuel and diesel fuel, wherein pilot injections of diesel fuel into the combustion chamber by a fuel injector according to the above ignites the hydrogen fuel. One problem for these types of engines is that a relatively large quantity of diesel fuel is needed for igniting the hydrogen fuel. Studies have shown that a few percent diesel fuel is needed for igniting the hydrogen fuel when using a fuel injector as described above.

Provided that the hydrogen fuel is created in a process that does not involve fossil carbon, this relatively large quantity of diesel fuel can constitute the only contributor to the emissions of fossil hydrocarbons from the engine. The same problem arises in engines configured to operate on other types of fuels, such as the combination of natural gas and diesel. This is because natural gas can provide a lower carbon footprint than a diesel fuel.

Thus, in engines configured to operate on two different fuels, such as a first fuel with a higher research octane number and a second fuel with a lower research octane number, it can be desired to minimize the injection of the second fuel for environmental reasons. However, a fuel injector normally has mechanical and fluid limitations which make it difficult to reduce the amount of the second fuel injected into the combustion chamber.

One possible way to reduce the amount of second fuel injected into the combustion chamber could be to reduce the number of holes for the second fuel. However, such a solution risks impairing the ignition process of the first fuel, which can increase the emission of unburnt fuel from the engine and increase the fuel consumption of the engine. Another possible way of reducing the amount of second fuel injected into the combustion chamber could be to provide the fuel injection holes for the second fuel with smaller cross-sectional areas. However, the cross-sectional area of a fuel injection hole is limited by manufacturing methods, and it can be difficult to manufacture fuel injection holes with small cross-sectional areas.

### SUMMARY

It is an object of the present invention to overcome, or at least alleviate, at least some of the above-mentioned problems and drawbacks.

According to a first aspect of the invention, the object is achieved by a fuel injector configured to inject a first and a second fuel into a combustion chamber of an internal combustion engine, wherein the second fuel is different from the first fuel. The fuel injector comprises a nozzle portion provided with a number of first fuel injection holes for injecting the first fuel into the combustion chamber, wherein the first fuel injection holes are circumferentially distributed on the nozzle portion around a center axis of the nozzle portion. The fuel injector further comprises a second fuel injection hole for injecting the second fuel into the combustion chamber. The second fuel injection hole is configured to inject the second fuel in a main fuel injection direction substantially coinciding with the center axis of the nozzle portion.

Since the second fuel injection hole is configured to inject the second fuel in a main fuel injection direction substantially coinciding with the center axis of the nozzle portion, a fuel injector is provided in which the second fuel can be redirected by a top surface of a piston of an engine comprising the fuel injector. As a result, the second fuel can reach portions of the combustion chamber into which the first fuel is injected. In other words, by being redirected by a top surface of a piston, the second fuel can be distributed into various parts of the combustion chamber to reach fuel stream formations from the number of first fuel injection holes, i.e., fuel stream formations containing the first fuel.

In this manner, a smaller amount of the second fuel can be injected into the combustion chamber while ensuring contact between fuel stream formations from the first and second fuel injection holes. In this manner, the fuel injector can for example be utilized to inject a first fuel having a higher research octane number than the second fuel, wherein the combustion of the second fuel can ignite the first fuel in an efficient manner while reducing the consumption of the second fuel.

As a further result, a fuel injector is provided capable of reducing the total carbon footprint of an engine comprising the fuel injector.

Accordingly, a fuel injector is provided overcoming, or at least alleviating, at least some of the above-mentioned problems and drawbacks. As a result, the above-mentioned object is achieved.

Optionally, the second fuel injection hole is configured such that the angle between the main fuel injection direction of the second fuel and the center axis of the nozzle portion is less than 15 degrees or is less than 10 degrees. Thereby, it can be ensured that the fuel stream formation from the second fuel injection hole hits a piston top of a piston of the engine at an angle which provides an even distribution of the second fuel into various parts of the combustion chamber. Thereby, it can be further ensured that the combustion of the second fuel ignites each fuel stream formation of the number of first fuel injection holes.

Optionally, the center axis of the nozzle portion extends through at least a portion of the second fuel injection hole. Thereby, it can be ensured that the fuel stream formation from the second fuel injection hole is evenly distributed into various parts of the combustion chamber such that the combustion of the second fuel ignites each fuel stream formation of the number of first fuel injection holes.

Optionally, a geometrical center line of the second fuel injection hole is parallel to the center axis of the nozzle portion. Thereby, it can be ensured that the fuel stream formation from the second fuel injection hole hits a piston top of a piston of the engine at an angle which provides an even distribution of the second fuel into various parts of the combustion chamber. Thereby, it can be further ensured that the combustion of the second fuel ignites each fuel stream formation of the number of first fuel injection holes.

Optionally, the fuel injector comprises one second fuel injection hole only. Thereby, it can be ensured that only a small amount of the second fuel is needed for ensuring combustion of the first fuel. As a further result, a fuel injector is provided capable of further reducing the carbon footprint of an engine comprising the fuel injector.

Optionally, the number of first fuel injection holes comprises at least three first fuel injection holes. Thereby, it can be ensured that the total volume of the combustion chamber can be utilized for an efficient combustion of a fuel.

Optionally, each first fuel injection hole of the number of first fuel injection holes is configured such that the angle between the main fuel injection direction of the first fuel and the center axis of the nozzle portion is greater than 30 degrees or is greater than 50 degrees. Thereby, it can be ensured that the first fuel reaches into various parts of the combustion chamber while ignition of the first fuel is ensured by the combustion of the second fuel.

Optionally, the fuel injector comprises a fuel injector body comprising a first fuel cavity configured to accommodate the first fuel, and a second fuel cavity configured to accommodate the second fuel, and wherein the fuel injector comprises a first needle seat, a first needle configured to interact with the first needle seat to open and close a fluid connection between the first fuel cavity and the number of first fuel injection holes, a second needle seat, and a second needle configured to interact with the second needle seat to open and close a fluid connection between the second fuel cavity and the second fuel injection hole. Thereby, a fuel injector is provided having conditions for a high degree of controllability of the injections of the first and second fuels.

Optionally, at least part of the second needle is arranged inside the first needle. Thereby, a compact fuel injector can be provided having conditions for a high degree of controllability of the injections of the first and second fuels.

Optionally, at least part of the second fuel cavity is arranged inside the first needle. Thereby, a compact fuel injector can be provided having conditions for a high degree of controllability of the injections of the first and second fuels.

Optionally, the second fuel injection hole extends through a portion of the first needle. Thereby, a compact fuel injector can be provided having conditions for a high degree of controllability of the injections of the first and second fuels.

Optionally, the second needle seat is formed by an inner surface of the first needle. Thereby, a compact fuel injector can be provided having conditions for a high degree of controllability of the injections of the first and second fuels.

Optionally, the first and second needles are configured to open and close the respective fluid connections by moving in directions parallel to the center axis of the nozzle portion. Thereby, a high degree of controllability of the injections of the first and second fuels can be ensured while providing conditions for a compact fuel injector.

According to a second aspect of the invention, the object is achieved by an internal combustion engine comprising a cylinder, a piston arranged in the cylinder and being arranged to reciprocate along a cylinder axis of the cylinder, a combustion chamber formed between walls of the cylinder and a piston top of the piston, and a fuel injector according to some embodiments of the present disclosure. The fuel injector is configured to inject the first fuel and the second fuel into the combustion chamber.

Since the internal combustion engine comprises a fuel injector according to some embodiments configured to inject the first fuel and the second fuel into the combustion chamber of the internal combustion engine, an internal combustion engine is provided having conditions for using a smaller amount of the second fuel while ensuring contact between fuel stream formations from the first and second fuel injection holes. This is because the second fuel injected by the second fuel injection hole can be redirected by the piston top of the piston into various parts of the combustion chamber to thereby reach the fuel stream formations of the number of first fuel injection holes.

Accordingly, in this manner, the internal combustion engine can be configured to operate on a first fuel having a higher research octane number than the second fuel, wherein the combustion of the second fuel can ignite the first fuel in an efficient manner while reducing the consumption of the second fuel. Accordingly, an internal combustion engine is provided having conditions for a reduced total carbon footprint.

Accordingly, an internal combustion engine is provided overcoming, or at least alleviating, at least some of the above-mentioned problems and drawbacks. As a result, the above-mentioned object is achieved.

Optionally, the angle between the main fuel injection direction of the second fuel and the cylinder axis of the cylinder is less than 15 degrees or is less than 10 degrees. Thereby, it can be ensured that the fuel stream formation from the second fuel injection hole hits the piston top of the piston of the engine at an angle which provides an even distribution of the second fuel into various parts of the combustion chamber. Thereby, it can be further ensured that the combustion of the second fuel ignites each fuel stream formation of the number of first fuel injection holes.

Optionally, the center axis of the nozzle portion is parallel to the cylinder axis of the cylinder. Thereby, it can be ensured that the fuel stream formation from the second fuel injection hole hits the piston top of the piston of the engine at an angle which provides an even distribution of the second fuel into various parts of the combustion chamber. Thereby, it can be further ensured that the combustion of the second fuel ignites each fuel stream formation of the number of first fuel injection holes.

Optionally, the center axis of the nozzle portion coincides with the cylinder axis of the cylinder. Thereby, it can be ensured that the fuel stream formation from the second fuel injection hole hits the piston top of the piston of the engine at an angle which provides an even distribution of the second fuel into various parts of the combustion chamber. Thereby, it can be further ensured that the combustion of the second fuel ignites each fuel stream formation of the number of first fuel injection holes.

Optionally, the piston top comprises a piston bowl and a protrusion protruding from a bottom surface of the piston bowl, and wherein the protrusion comprises a fuel impingement surface facing the fuel injector. Thereby, it can be further ensured that the second fuel is distributed in an efficient manner into various parts of the combustion chamber to thereby ignite each fuel stream formation of the number of first fuel injection holes.

Optionally, the fuel impingement surface is substantially flat. Thereby, an even distribution of the second fuel can be provided into various parts of the combustion chamber of the internal combustion engine.

Optionally, the fuel impingement surface is convex. Thereby, it can be ensured that the second fuel redirected by the fuel impingement surface reaches radially outer portions of the fuel stream formations of the number of first fuel injection holes.

Optionally, the fuel impingement surface is concave. Thereby, it can be ensured that the second fuel redirected by the fuel impingement surface reaches radially inner portions of the fuel stream formations of the number of first fuel injection holes.

Optionally, the fuel impingement surface comprises a first portion located at a radial center of the fuel impingement surface and a second portion surrounding the first portion, and wherein the first portion is convex and the second portion is concave. Thereby, fuel of radially inner portions of the fuel stream formation of the second fuel injection hole, which hits the first portion fuel impingement surface, can be directed in more radial directions and fuel of radially outer portions of the fuel stream formation of the second fuel injection hole, which hits the second portion, can be directed in more axial directions towards a cylinder top of the cylinder. In this manner, it can be further ensured that the combustion of the second fuel ignites all fuel stream formations of the number of first fuel injection holes.

Optionally, the fuel impingement surface is patterned. Thereby, an internal combustion engine is provided in which the reflection and direction of the second fuel can be controlled by the design of the pattern of the fuel impingement surface. In this manner, it can be further ensured that the redirected second fuel can reach all fuel stream formations of the number of first fuel injection holes in an efficient manner.

Optionally, the internal combustion engine is a compression ignition engine. Thereby, the internal combustion engine can be configured to operate on a first fuel having a higher research octane number than the second fuel, wherein the second fuel is ignited by the compression heat in the combustion chamber to thereby ignite the first fuel. Since the second fuel injection hole is configured to inject the second fuel in a main fuel injection direction substantially coinciding with the center axis of the nozzle portion, conditions are provided for a lower consumption of the second fuel while ensuring combustion of the first fuel.

Optionally, the first fuel has a higher research octane number than the second fuel. Thereby, the second fuel can be ignited for example by the compression heat in the combustion chamber to thereby ignite the first fuel. Since the second fuel injection hole is configured to inject the second fuel in a main fuel injection direction substantially coinciding with the center axis of the nozzle portion, conditions are provided for a lower consumption of the second fuel while ensuring combustion of the first fuel.

Optionally, the first fuel has a research octane number above 50, and wherein the second fuel has a research octane number below 50. Thereby, the second fuel can be ignited for example by the compression heat in the combustion chamber to thereby ignite the first fuel. Since the second fuel injection hole is configured to inject the second fuel in a main fuel injection direction substantially coinciding with the center axis of the nozzle portion, conditions are provided for a lower consumption of the second fuel while ensuring combustion of the first fuel.

Optionally, the first fuel is a gaseous fuel and the second fuel is a liquid fuel. Thereby, a Bi-fuel engine is provided having conditions for igniting the gaseous fuel in an efficient manner while only using small quantities of the liquid fuel. As a further result, a Bi-fuel engine is provided having conditions for a reduced carbon footprint.

Optionally, the first fuel comprises hydrogen gas and/or natural gas, and wherein the second fuel comprises diesel and/or a diesel-like fuel. Thereby, a Bi-fuel engine is provided having conditions for igniting the hydrogen gas and/or natural gas in an efficient manner while only using small quantities of the diesel and/or a diesel-like fuel. As a further result, a Bi-fuel engine is provided having conditions for a reduced carbon footprint.

According to a third aspect of the invention, the object is achieved by a vehicle comprising an internal combustion engine according to some embodiments of the present disclosure. Since the vehicle comprises an internal combustion engine according to some embodiments, a vehicle is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments,

FIG. 2 schematically illustrates an internal combustion engine of the vehicle illustrated in FIG. 1,

FIG. 3 illustrates a perspective view of a piston of the internal combustion engine illustrated in FIG. 1 and FIG. 2,

FIG. 4 schematically illustrates a portion of the internal combustion engine illustrated in FIG. 1 and FIG. 2,

FIG. 5 schematically illustrates fuel stream formations of a first fuel and a fuel stream formation of a second fuel in a combustion chamber of the internal combustion engine illustrated in FIG. 1, FIG. 2, and FIG. 4,

FIG. 6 schematically illustrates a cross section of the portion of the internal combustion engine illustrated in FIG. 4,

FIG. 7 schematically illustrates a portion of an internal combustion engine according to some further embodiments,

FIG. 8 schematically illustrates a portion of an internal combustion engine according to some further embodiments, and

FIG. 9 schematically illustrates a portion of an internal combustion engine according to some further embodiments.

### DETAILED DESCRIPTION

Aspects of the present invention will now be described more fully. Like reference signs refer to like elements throughout. Well-known functions or constructions will not necessarily be described in detail for brevity and/or clarity.

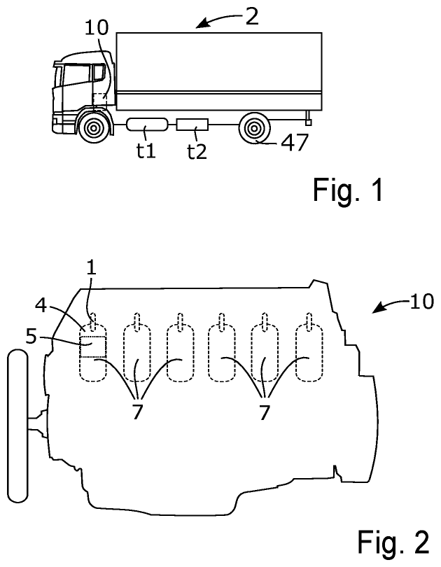

FIG. 1 schematically illustrates a vehicle 2 according to some embodiments. According to the illustrated embodiments, the vehicle 2 is a truck, i.e., a type of heavy vehicle. According to further embodiments, the vehicle 2, as referred to herein, may be another type of heavy or lighter type of manned or unmanned vehicle for land or water-based propulsion such as a lorry, a bus, a construction vehicle, a tractor, a car, a ship, a boat, or the like.

The vehicle 2 comprises an internal combustion engine 10. According to the illustrated embodiments, the internal combustion engine 10 is configured to provide motive power to the vehicle 2 via wheels 47 of the vehicle 2.

The vehicle 2 comprises a first fuel tank t1 configured to store a first fuel and a second fuel tank t2 configured to store a second fuel, wherein the second fuel is different from the first fuel. As is further explained herein, the internal combustion engine 10 of the vehicle 2 is a so-called Bi-fuel engine configured to operate on each of the first and second fuels.

The vehicle 2 may comprise one or more electric propulsion motors in addition to the internal combustion engine 10 for providing motive power to the vehicle 2. Thus, the vehicle 2, as referred to herein, may comprise a so-called hybrid electric powertrain comprising one or more electric propulsion motors in addition to the combustion engine 10 for providing motive power to the vehicle 2.

FIG. 2 schematically illustrates the internal combustion engine 10 of the vehicle 2 illustrated in FIG. 1. The internal combustion engine 10 is in some places herein referred to as the “combustion engine 10”, or simply “the engine 10”, for reasons of brevity and clarity. Below, simultaneous reference is made to FIG. 1 and FIG. 2, if not indicated otherwise.

According to the illustrated embodiments, the internal combustion engine 10 comprises six cylinders 7 arranged in one row. The internal combustion engine 10 according to the illustrated embodiments may therefore be referred to an inline-six engine. However, according to further embodiments, the internal combustion engine 10, as referred to herein, may comprise another number of cylinders 7. Moreover, the cylinders 7 of the internal combustion engine 10 may be arranged in another configuration than in one row, such as in two or more rows.

The internal combustion engine 10 comprises a piston 5 arranged in each cylinder 7, wherein the pistons 5 are connected to a crankshaft of the internal combustion engine 10. The pistons 5 are configured to reciprocate in the cylinders 7 upon rotation of the crankshaft. Combustion chambers 4 are formed between a piston top of each piston 5 and cylinder walls of the cylinders 7 of the internal combustion engine 10. Only one piston 5 of one cylinder 7 and only the combustion chamber 4 of this cylinder 7 is schematically indicated in FIG. 2 for reasons of brevity and clarity. However, the internal combustion engine 10 comprises one piston 5 arranged in each cylinder 7 as explained above and combustion chambers 4 are formed between each piston top of the pistons 5 and cylinder walls of the cylinders 7 of the internal combustion engine 10.

The internal combustion engine 10 comprises a number of fuel injectors 1, wherein each fuel injector 1 is configured to inject a first and a second fuel into a combustion chamber 4 the internal combustion engine 10. According to the illustrated embodiments, the internal combustion engine 10 comprises the same number of fuel injectors 1 as the number of cylinders 7. Moreover, according to the illustrated embodiments, each fuel injector 1 is configured to inject the first and second fuels directly into a combustion chamber 4 the internal combustion engine 10.

According to the illustrated embodiments, the internal combustion engine 10 is a four-stroke compression ignition engine 10. As understood from the above, according to the illustrated embodiments, the engine 10 is configured to provide motive power to a vehicle comprising the engine 10. However, according to further embodiments, the engine 10, as referred to herein, may be configured to power another type of unit, device, or system than a vehicle, such as for example an electric generator.

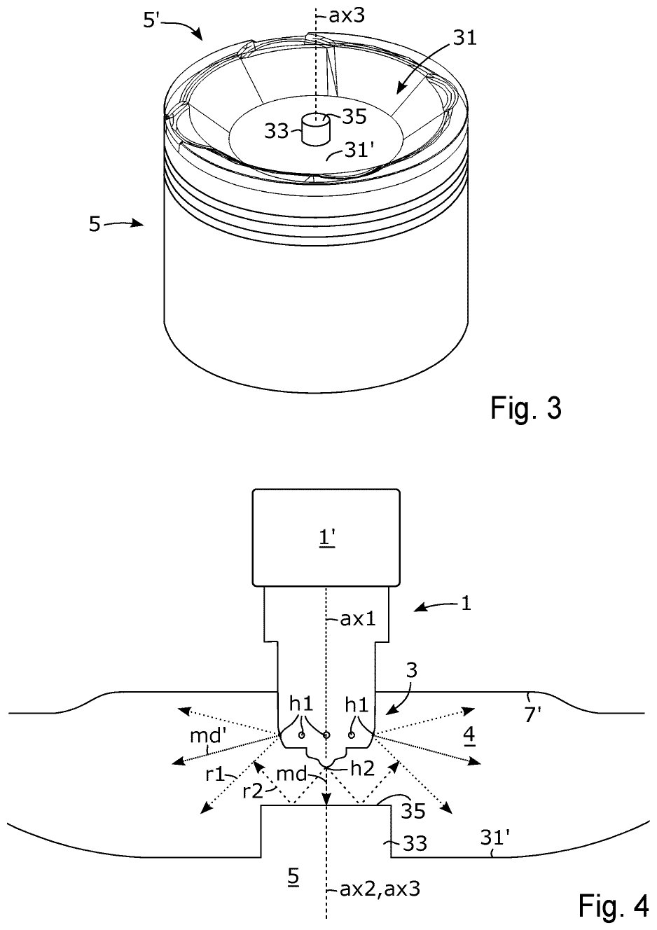

FIG. 3 illustrates a perspective view of a piston 5 of the internal combustion engine 10 illustrated in FIG. 1 and FIG. 2. Below, simultaneous reference is made to FIG. 1-FIG. 3, if not indicated otherwise. The piston 5 is configured to reciprocate along a cylinder axis of a cylinder 7 of the engine 10. The piston 5 comprises a center axis ax3. The center axis ax3 of the piston 5 coincides with the cylinder axis of the cylinder 7 when the piston 5 is arranged in the cylinder 7.

The piston 5 comprises a piston top 5′. The piston top 5′ faces a cylinder head of the cylinder 7 when the piston 5 is arranged in the cylinder 7. Moreover, the piston top 5′ faces a fuel injector 1 of the cylinder when the piston 5 is arranged in the cylinder 7. According to the illustrated embodiments, the piston top 5′ comprises a piston bowl 31 and a protrusion 33 protruding from a bottom surface 31′ of the piston bowl 31. The protrusion 33 comprises a fuel impingement surface 35 which faces the fuel injector 1 when the piston 5 is arranged in the cylinder 7. The features, functions, and advantages of the fuel impingement surface 35 is further explained below.

FIG. 4 schematically illustrates a portion of the internal combustion engine 10 illustrated in FIG. 1 and FIG. 2. In FIG. 4, a portion of a piston 5 can be seen. The piston 5 is a piston according to the embodiments illustrated in FIG. 3. The piston 5 is arranged in a cylinder such that the center axis ax3 of the piston 5 coincides with a cylinder axis ax2 of the cylinder. Moreover, in FIG. 4 cylinder walls 7′ of the cylinder is indicated. In FIG. 4, the cylinder walls 7′ of the cylinder are inner walls of a cylinder head of the cylinder. A combustion chamber 4 is formed between walls 7′ of the cylinder and the piston top 5′ of the piston 5.

The cylinder head of the cylinder may comprise a number of inlet valves and a number of outlet valves, wherein the number of inlet valves may be arranged to control the flow of air into the combustion chamber 4, and wherein the number of outlet valves may be configured to control the flow of gas out of the combustion chamber 4. The number of outlet valves may also be referred to as a number of exhaust valves. These types of valves are not illustrated in FIG. 4 for reasons of brevity and clarity.

Moreover, FIG. 4 schematically illustrates a fuel injector 1. The fuel injector 1 is attached to the cylinder head of the cylinder and comprises a nozzle portion 3. The nozzle portion 3 of the fuel injector 1 protrudes into the combustion chamber 4.

The fuel injector 1 is configured to inject the first fuel and the second fuel into the combustion chamber 4. In more detail, the nozzle portion 3 of the fuel injector 1 is provided with a number of first fuel injection holes h1 for injecting the first fuel into the combustion chamber 4. As seen in FIG. 4, the first fuel injection holes h1 of the number of first fuel injection holes h1 are circumferentially distributed on the nozzle portion 3 around a center axis ax1 of the nozzle portion 3.

The nozzle portion 3 of the fuel injector 1 is also provided with a second fuel injection hole h2 for injecting the second fuel into the combustion chamber 4. In FIG. 4, a control portion 1′ of the fuel injector 1 is schematically indicated with a box. As is further explained herein, the control portion 1′ of the fuel injector 1 may comprise connections for the respective first and second fuels and may comprise hydraulic, electric, and/or pneumatic control arrangements for controlling the injection of the respective first and second fuels into the combustion chamber 4.

Moreover, a vehicle comprising the fuel injector 1, such as the vehicle 2 illustrated in FIG. 1, may comprise a first fuel supply system configured to supply the first fuel from the first fuel tank t1 to the fuel injector 1 and a second fuel supply system for supplying the second fuel from the second fuel tank t2 to the fuel injector 1.

According to the illustrated embodiments, the first fuel is a gaseous fuel and the second fuel is a liquid fuel. According to further embodiments, each of the first and second fuels may be a liquid fuel. Moreover, according to some further embodiments, each of the first and second fuels may be a gaseous fuel. Furthermore, according to some embodiments, the first fuel, as referred to herein, may be a liquid fuel and the second fuel may be a gaseous fuel.

The gaseous fuel may comprise hydrogen gas, natural gas, biogas, methane, propane, butane, and/or mixtures thereof. The liquid fuel may comprise diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME). As an alternative, or in addition, the liquid fuel may comprise petrol, alcohol, such as ethanol or methanol, similar volatile fuels, or combinations thereof. Alcohol, such as ethanol or methanol, can be derived from renewable biomass.

According to embodiments herein, the first fuel has a higher research octane number than the second fuel. According to some embodiments, the first fuel has a research octane number above 50 and the second fuel has a research octane number below 50. The research octane number of a fuel indicates the fuel's ability to withstand compression in a combustion chamber 4 without igniting. The term research octane number is sometimes abbreviated “RON”. The higher the research octane number, the more compression the fuel can withstand before igniting. In other words, a fuel with a high research octane number has a high ability to withstand compression before igniting whereas a fuel with a low research octane number has a low ability to withstand compression before igniting. Diesel and diesel like fuels typically have a research octane number of about 15-25. Hydrogen fuel typically has a research octane number exceeding 130. Methane, which is the primary constituent of natural gas, has a research octane number of about 120.

As seen in FIG. 4, the second fuel injection hole h2 is configured to inject the second fuel in a main fuel injection direction md substantially coinciding with the center axis ax1 of the nozzle portion 3. The fuel injector 1 may be controlled to inject the second fuel when the piston 5 of the cylinder is in a region of the top dead center. In this manner, the second fuel can be redirected by a top surface of the piston 5, such as the fuel impingement surface 35 of the protrusion 33 of the piston 5, to be distributed into various parts of the combustion chamber 4 to thereby reach fuel stream formations from the number of first fuel injection holes h1, i.e., fuel stream formations containing the first fuel.

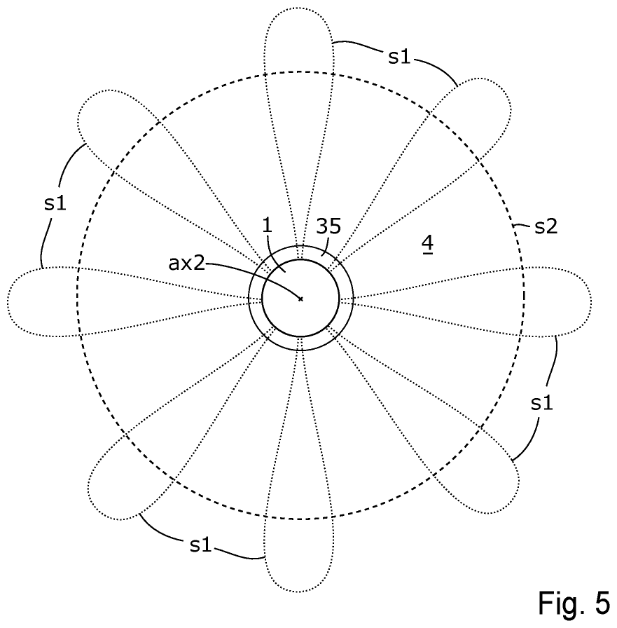

FIG. 5 schematically illustrates fuel stream formations s1 of the first fuel and a fuel stream formation s2 of the second fuel in the combustion chamber 4 illustrated in FIG. 4. In FIG. 5, the fuel stream formations s1, s2 are illustrated as seen in a direction coinciding with the cylinder axis ax2 of the cylinder. Moreover, in FIG. 5, the fuel injector 1 and the fuel impingement surface 35 are schematically indicated.

As mentioned, according to the illustrated embodiments, the engine is a compression ignition engine and the second fuel has a lower research octane number than the second fuel. Moreover, the engine is configured such that the second fuel is ignited by the compression heat generated in the compression phase of the cylinder. The fuel stream formation s2 of the second fuel redirected by the fuel impingement surface 35 will thus be ignited by the compression heat generated in the compression phase of the cylinder.

The dashed circle denoted with the reference sign s2 in FIG. 5 can thus be said to represent a burning flame of the second fuel. Since the second fuel is redirected to reach the fuel stream formations s1 of the first fuel, the fuel stream formations s1 of the first fuel can be ignited at least substantially simultaneously by the burning flame of the second fuel.

In this manner, a smaller amount of the second fuel can be injected into the combustion chamber 4 while ensuring ignition of the fuel stream formations s1 of the first fuel. That is, prior art fuel injectors for injecting two different fuels into a combustion chamber normally comprise the same number of fuel injection holes for the two different fuels, wherein the fuel injection holes are arranged and oriented such that adjacent pair of fuel stream formations are obtained in the combustion chamber. In this manner, the combustion of the fuel of a fuel stream formation with the lower research octane number can ignite the fuel of a fuel stream formation with the higher research octane number. However, such fuel injectors need to inject a relatively large amount of the fuel with the lower research octane number in order to ensure ignition of all fuel stream formations of the other fuel.

Accordingly, since the nozzle portion of the fuel injector 1 according to embodiments herein is provided with the second fuel injection hole configured to inject the second fuel in a main fuel injection direction substantially coinciding with the center axis of the nozzle portion, the second fuel can be redirected by a portion of the piston, such as the fuel impingement surface 35 of the piston, to thereby ignite the first fuel using a small amount of the second fuel.

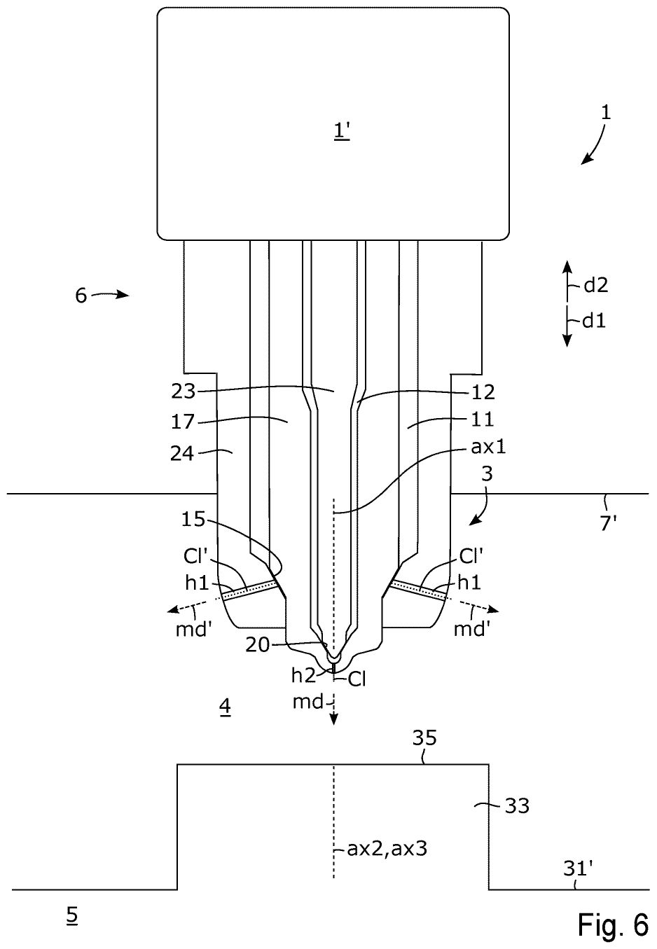

FIG. 6 schematically illustrates a cross section of the portion of the internal combustion engine illustrated in FIG. 4. Like in FIG. 4, a portion of a piston 5 can be seen in FIG. 6. In FIG. 4 and FIG. 6, the piston is illustrated as being located at a region of the top dead center. Moreover, like in FIG. 4, cylinder walls 7′ of the cylinder are schematically indicated in FIG. 6. Furthermore, like in FIG. 4, the fuel injector 1 can be seen in FIG. 6. However, in FIG. 6, the fuel injector 1 is seen in a cross section. The cross section of FIG. 6 is made in a plane comprising the cylinder axis ax2 of the cylinder.

According to the illustrated embodiments, the fuel injector 1 is attached to the cylinder of the engine such that the center axis ax1 of the nozzle portion 3 is parallel to the cylinder axis ax2 of the cylinder 7. Moreover, according to the illustrated embodiments, the fuel injector 1 is attached to the cylinder of the engine such that the center axis ax1 of the nozzle portion 3 coincides with the cylinder axis ax2 of the cylinder 7.

In FIG. 6, the second fuel injection hole h2 and two first fuel injection holes h1 of the number of first fuel injection holes h1 can be seen. According to the illustrated embodiments, the number of first fuel injection holes h1 comprises eight first fuel injection holes h1. However, according to further embodiments, the number of first fuel injection holes h1 may comprise another number of first fuel injection holes h1, such as 3—25 first fuel injection holes h1, or 3—16 first fuel injection holes h1.

Moreover, according to the illustrated embodiments, the fuel injector 1 comprises one second fuel injection hole h2 only. However, according to further embodiments, the fuel injector 1 may comprise two or more adjacent second fuel injection holes.

According to the illustrated embodiments, the second fuel injection hole h2 is configured to inject the second fuel in a main fuel injection direction md coinciding with the center axis ax1 of the nozzle portion 3. In other words, according to the illustrated embodiments, the second fuel injection hole h2 is configured such that the angle between the main fuel injection direction md of the second fuel and the center axis ax1 of the nozzle portion 3 is zero degrees.

According to further embodiments, the second fuel injection hole h2 may be configured to inject the second fuel in a main fuel injection direction md substantially coinciding with the center axis ax1 of the nozzle portion 3. The feature that the main fuel injection direction md substantially coincides with the center axis ax1 of the nozzle portion 3 may encompass that the angle between the main fuel injection direction md of the second fuel and the center axis ax1 of the nozzle portion 3 is less than 15 degrees or is less than 10 degrees. In other words, the second fuel injection hole h2 may be configured such that the angle between the main fuel injection direction md of the second fuel and the center axis ax1 of the nozzle portion 3 is less than 15 degrees or is less than 10 degrees. Moreover, the fuel injector 1 may be attached to the cylinder of the internal combustion engine such that the angle between the main fuel injection direction md of the second fuel and the cylinder axis ax2 of the cylinder is less than 15 degrees or is less than 10 degrees.

As seen in FIG. 6, the center axis ax1 of the nozzle portion 3 extends through the second fuel injection hole h2. Moreover, according to the illustrated embodiments, a geometrical center line Cl of the second fuel injection hole h2 coincides with the center axis ax1 of the nozzle portion 3. In other words, according to the illustrated embodiments, the geometrical center line Cl of the second fuel injection hole h2 is parallel to the center axis ax1 of the nozzle portion 3.

The geometrical center line Cl of the second fuel injection hole h2 is a line positioned such that the radial distances from the line to inner delimiting surfaces of the second fuel injection hole h2 are maximized in all radial directions. The main fuel injection direction md of the second fuel coincides with the geometrical center line Cl of the second fuel injection hole h2. The main fuel injection direction md as referred to herein may also be referred to as an average fuel injection direction of the fuel

Moreover, in FIG. 6, a respective center line Cl′ of the two first fuel injection holes h1 are indicated. Like above, the geometrical center line Cl′ of the first fuel injection hole h1 is a line positioned such that the radial distances from the line to inner delimiting surfaces of the first fuel injection hole h1 are maximized in all radial directions. The main fuel injection directions md′ of the first fuel from a first fuel injection hole h1 coincides with the geometrical center line Cl′ of the first fuel injection hole h1.

According to the illustrated embodiments, each first fuel injection hole h1 of the number of first fuel injection holes h1 is configured such that the angle between the main fuel injection direction md′ of the first fuel and the center axis ax1 of the nozzle portion 3 is approximately 80 degrees. According to further embodiments, each first fuel injection hole h1 of the number of first fuel injection holes h1 may be configured such that the angle between the main fuel injection direction md′ of the first fuel and the center axis ax1 of the nozzle portion 3 is greater than 30 degrees or is greater than 50 degrees. Moreover, according to some embodiments, each first fuel injection hole h1 of the number of first fuel injection holes h1 may be configured such that the angle between the main fuel injection direction md′ of the first fuel and the center axis ax1 of the nozzle portion 3 is within the range of 30 -130 degrees, or is within the range of 50-110 degrees.

According to the illustrated embodiments, the second fuel injection hole h2 has a considerably smaller diameter than each of the number of first fuel injection holes h1. Purely as examples, each of the number of first fuel injection holes h1 may have a diameter within the range of 0.2-1 mm, or within the range of 0.5-0.8 mm. Moreover, the second fuel injection hole h2 may have a diameter within the range of 0.07-0.18 mm, or within the range of 0.07-0.13 mm. Moreover, according to some embodiments, each of the number of first fuel injection holes h1 may have a diameter being at least twice as large as the diameter of the second fuel injection hole h2. The diameter of a fuel injection hole h1, h2 may be measured in a plane perpendicular to the geometrical center line Cl, Cl′ of the fuel injection hole h1, h2.

In the following, some of the structural parts of the fuel injector 1 is explained. The fuel injector 1 comprises a fuel injector body 6 comprising a first fuel cavity 11 and a second fuel cavity 12. The first fuel cavity 11 is configured to accommodate the first fuel and the second fuel cavity 12 configured to accommodate the second fuel. The engine comprising the fuel injector 1 may comprise a first fuel supply system configured to supply the first fuel to the first fuel cavity 11 and may comprise a second fuel supply system configured to supply the second fuel to the second fuel cavity 12.

Also in FIG. 6, a control portion 1′ of the fuel injector 1 is schematically indicated with a box. The control portion 1′ of the fuel injector 1 may comprise a first connection connected to the first fuel cavity 11 and a second connection connected to the second fuel cavity 12. One or both of the first and second fuel supply systems may be configured to supply pressurized fuel to the respective first and second connections, i.e., to the respective first and second fuel cavities 11, 12.

The fuel injector 1 comprises a first needle seat 15 and a first needle 17 configured to interact with the first needle seat 15 to open and close a fluid connection between the first fuel cavity 11 and the number of first fuel injection holes h1. According to the illustrated embodiments, the fuel injector 1 comprises an outer sleeve-shaped part 24, wherein the first needle seat 15 is provided on a portion of the outer sleeve-shaped part 24. Moreover, according to the illustrated embodiments, the number of first fuel injection holes h1 are provided in, and extends through, the outer sleeve-shaped part 24.

The fuel injector 1 further comprises a second needle seat 20 and a second needle 23 configured to interact with the second needle seat 20 to open and close a fluid connection between the second fuel cavity 12 and the second fuel injection hole h2. As can be seen in FIG. 6, according to the illustrated embodiments, the second needle seat 20 is formed by an inner surface of the first needle 17. Moreover, according to the illustrated embodiments, the second fuel injection hole h2 is provided in, and extends through, a portion of the first needle 17.

As seen in FIG. 6, according to the illustrated embodiments, at least part of the second needle 23 is arranged inside the first needle 17. Moreover, at least part of the second fuel cavity 12 is arranged inside the first needle 17. According to the illustrated embodiments, the first and second needles 17, 23 are configured to open and close the respective fluid connections by moving in directions d1, d2 parallel to the center axis ax1 of the nozzle portion 3.

In more detail, the first needle 17 is movably arranged relative to the fuel injector body 6 between a closed position in which a portion of the first needle 17 abuts against the first needle seat 15 to close a fluid connection between the first fuel cavity 11 and the number of first fuel injection holes h1 and an open position in which the portion of the first needle 17 is lifted from the first needle seat 15 to open the fluid connection between the first fuel cavity 11 and the number of first fuel injection holes h1. In FIG. 6, the first needle 17 is illustrated in the closed position and is movably arranged therefrom in the direction d2 illustrated in FIG. 6.

Likewise, the second needle 23 is movably arranged relative to the fuel injector body 6 between a closed position in which a portion of the second needle 23 abuts against the second needle seat 20 to close a fluid connection between the second fuel cavity 12 and the second fuel injection hole h2 and an open position in which the portion of the second needle 23 is lifted from the second needle seat 20 to open the fluid connection between the second fuel cavity 12 and the second fuel injection hole h2. In FIG. 6, the second needle 13 is illustrated in the closed position and is movably arranged therefrom in the direction d2 illustrated in FIG. 6.

The control portion 1′ of the fuel injector 1 may comprise hydraulic, electric, and/or pneumatic control arrangements for moving the first and second needles 17, 23 between the open and closed positions. Since the second needle 23 is arranged inside the first needle 17 and since the second needle seat 20 is formed by an inner surface of the first needle 17, the second needle 23 is moved towards the open position by moving in the direction d2 relative to the first needle 17. Likewise, the second needle 23 is moved towards the closed position by moving in the direction d1 relative to the first needle 17. Moreover, as understood from the above, the first and second needles 17, 23 move in unison in the direction d2 when the first needle 17 is moved towards the open position.

According to some embodiments, in an injection procedure of the fuel injector 1, the second needle 23 is moved towards the open position prior to the first needle 17. As a result, the second fuel is injected into the combustion chamber 4 in the first main fuel injection direction md indicated in FIG. 6 prior to the first fuel.

In FIG. 4, a dashed arrow r2 schematically indicates the reflection of a radially outer part of the fuel stream formation of the second fuel from the second fuel injection hole h2 against the fuel impingement surface 35. Since the engine 10 is a compression ignition engine and since the second fuel has a relatively low research octane number according to the illustrated embodiments, the second fuel is ignited by the compression heat in the combustion chamber 4.

According to some embodiments, the first needle 17 may be moved towards the open position after ignition of the second fuel. When the first needle 17 is moved to the open position, the first fuel is injected into the combustion chamber 4. In FIG. 4, the dotted arrows r1 indicate radially outer parts of fuel stream formations of the first fuel from the first fuel injection holes h1. As seen in FIG. 4, the second fuel is redirected by the fuel impingement surface 35 such that the second fuel reaches the first fuel in the combustion chamber 4. In this manner, the combustion of the second fuel can ignite the first fuel in an efficient manner.

The second needle 23 may be moved to the closed position prior to moving the first needle 17 to the open position. In other words, the fuel injection of the second fuel may be stopped before initiating injection of the first fuel. The fuel injection of the second fuel may also be referred to as a pilot fuel injection of the second fuel.

According to some embodiments, the control portion 1′ of the fuel injector 1 may be configured to utilize the hydraulic pressure of the second fuel for moving the second needle 23 between the open and closed positions. Likewise, control portion 1′ of the fuel injector 1 may be configured to utilize the hydraulic pressure of the second fuel for moving the first needle 17 between the open and closed positions. The second fuel supply system, referred to above, may be a so-called common rail fuel supply system configured to supply the second fuel to the second fuel cavity 12 at a high fuel pressure, such as a fuel pressure exceeding 50 bar.

As seen in FIG. 4, according to the illustrated embodiments, the fuel injector 1 and the protrusion 33 are configured such that the fuel stream formations of the first fuel are not redirected by the fuel impingement surface 35. One reason for this is that the protrusion 33 including the fuel impingement surface 35 thereof, is relatively narrow. In this manner, it can be ensured that the second fuel is redirected by the fuel impingement surface 35 while the first fuel is not redirected by the fuel impingement surface 35. According to the illustrated embodiments the diameter of the fuel impingement surface 35 is approximately 12 mm as measured in a plane perpendicular to the center axis ax3 of the piston 5. However, the diameter of the fuel impingement surface 35 may be within the range of 6-25 mm, or may be within the range of 8-16 mm as measured in a plane perpendicular to the center axis ax3 of the piston 5.

Moreover, according to some further embodiments, the piston 5 may comprise a considerably larger protrusion 33 with a considerably larger fuel impingement surface 35. According to such embodiments, as well as other embodiments herein, the fuel injector 1 and the protrusion 33 may be configured such that the fuel stream formations of each of the first and second fuels are redirected by the fuel impingement surface 35 of the protrusion 33.

According to the embodiments illustrated in FIG. 3, FIG. 4, and FIG. 6, the fuel impingement surface 35 is substantially flat. The wording “substantially flat”, as used herein, may encompass that the fuel impingement surface 35 deviates less than 7% from the shape of a flat plane oriented perpendicularly to the center axis ax3 of the piston 5.

FIG. 7 schematically illustrates a portion of an internal combustion engine according to some further embodiments. The internal combustion engine may comprise the same features, functions, and advantages as the internal combustion engine 10 explained with reference to FIG. 1-FIG. 6, with some differences pointed out below. Moreover, the fuel injector 1 of the internal combustion engine illustrated in FIG. 7 may comprise the same features, functions, and advantages as the fuel injector 1 explained with reference to FIG. 2 6.

The piston 5 of internal combustion engine illustrated in FIG. 7 comprises a protrusion 33 with a fuel impingement surface 35′ being convex. As seen when comparing FIG. 4 and FIG. 7, the convex shape of the fuel impingement surface 35′ in FIG. 7 results in that the fuel stream formation of the second fuel is redirected to obtain different redirection angles as compared to the substantially flat fuel impingement surface 35 illustrated in FIG. 4.

In more detail, the convex shape of the fuel impingement surface 35′ illustrated in FIG. 7 causes the second fuel to be redirected to obtain more movement in radial directions relative to the cylinder axis ax2 of the cylinder and less movement in axial directions relative to the cylinder axis ax2 of the cylinder as compared to the substantially flat shape of the fuel impingement surface 35 illustrated in FIG. 4.

In other words, the convex shape of the fuel impingement surface 35′ illustrated in FIG. 7 causes the second fuel to be redirected to reach further radially into the combustion chamber 4 as compared to the substantially flat shape of the fuel impingement surface 35 illustrated in FIG. 4. The convex shape according to the embodiments illustrated in FIG. 7 may for example be utilized when wanting to distribute the second fuel further into the combustion chamber 4 in radial directions relative to the cylinder axis ax2 of the cylinder.

Moreover, the more radial redirections of the second fuel caused by the convex shape of the fuel impingement surface 35′ illustrated in FIG. 7 may be utilized when wanting to slightly delay the ignition timing of the first fuel, and/or when wanting to ignite the first fuel at locations further from the number of first fuel injection holes h1 of the fuel injector 1.

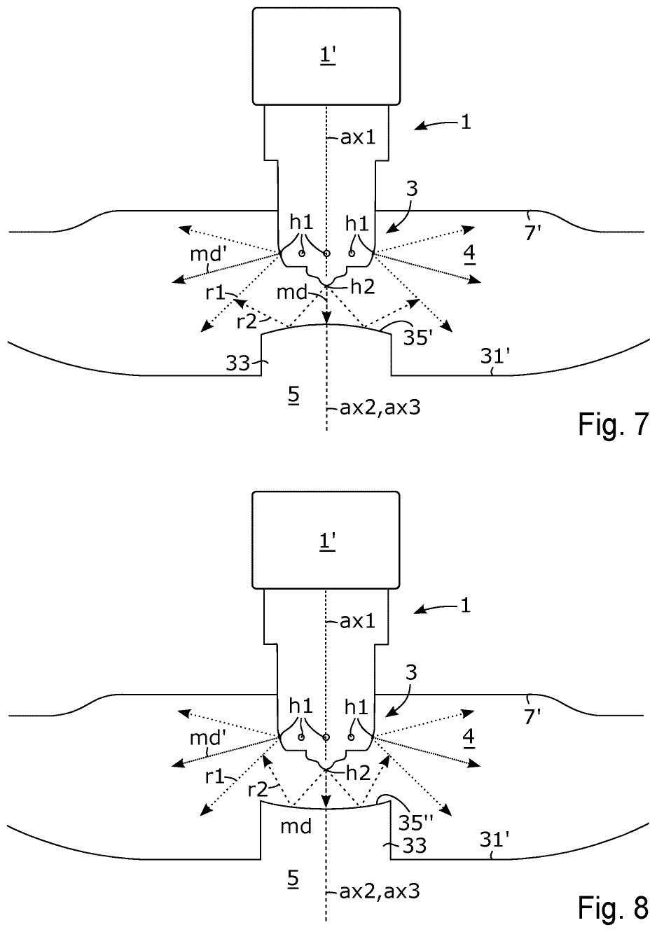

FIG. 8 schematically illustrates a portion of an internal combustion engine according to some further embodiments. The internal combustion engine illustrated in FIG. 8 may comprise the same features, functions, and advantages as the internal combustion engine 10 explained with reference to FIG. 1-FIG. 6, with some differences pointed out below. Moreover, the fuel injector 1 of the internal combustion engine illustrated in FIG. 8 may comprise the same features, functions, and advantages as the fuel injector 1 explained with reference to FIG. 2-6 .

The piston 5 of internal combustion engine illustrated in FIG. 8 comprises a protrusion 33 with a fuel impingement surface 35″ being concave. As seen when comparing FIG. 4 and FIG. 8, the concave shape of the fuel impingement surface 35″ in FIG. 8 results in that the fuel stream formation of the second fuel is redirected to obtain different redirection angles as compared to the substantially flat fuel impingement surface 35 illustrated in FIG. 4.

In more detail, the concave shape of the fuel impingement surface 35″ illustrated in FIG. 8 causes the second fuel to be redirected to obtain less movement in radial directions relative to the cylinder axis ax2 of the cylinder and more movement in axial directions relative to the cylinder axis ax2 of the cylinder as compared to the substantially flat shape of the fuel impingement surface 35 illustrated in FIG. 4.

In other words, the concave shape of the fuel impingement surface 35″ illustrated in FIG. 8 causes the second fuel to be redirected to reach less radially into the combustion chamber 4 as compared to the substantially flat shape of the fuel impingement surface 35 illustrated in FIG. 4. The concave shape according to the embodiments illustrated in FIG. 8 may for example be utilized when wanting to distribute the second fuel more towards the number of first fuel injection holes h1 and less into the combustion chamber 4 in radial directions relative to the cylinder axis ax2 of the cylinder.

Moreover, the more radial redirections of the second fuel caused by the concave shape of the fuel impingement surface 35″ illustrated in FIG. 8 may be utilized when wanting to slightly advance the ignition timing of the first fuel, and/or when wanting to ignite the first fuel at locations closer to the number of first fuel injection holes h1 of the fuel injector 1.

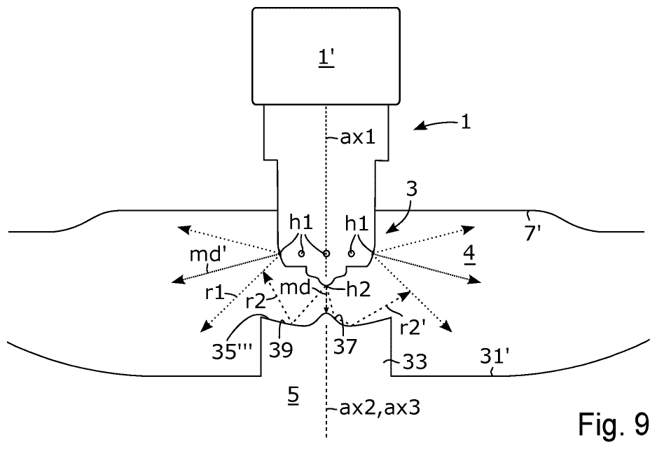

FIG. 9 schematically illustrates a portion of an internal combustion engine according to some further embodiments. The internal combustion engine illustrated in FIG. 9 may comprise the same features, functions, and advantages as the internal combustion engine 10 explained with reference to FIG. 1-FIG. 6, with some differences pointed out below. Moreover, the fuel injector 1 of the internal combustion engine illustrated in FIG. 9 may comprise the same features, functions, and advantages as the fuel injector 1 explained with reference to FIG. 2-6 .

The piston 5 of internal combustion engine illustrated in FIG. 9 comprises a protrusion 33 with a fuel impingement surface 35′″ comprising a first portion 37 located at a radial center of the fuel impingement surface 35′″ and a second portion 39 surrounding the first portion 37, wherein the first portion 37 is convex and the second portion 39 is concave. The wording “radial center” as used herein means a center seen radially in relation to the center axis ax3 of the piston 5. According to the illustrated embodiments, the radius of the radial center of the fuel impingement surface 35′″ is approximately 13% of the total radius of the fuel impingement surface 35′″.

In FIG. 9, a first dashed arrow r2 schematically indicates the redirection of the second fuel from the second fuel injection hole h2 against the concave second portion 39 of the fuel impingement surface 35′″ whereas a second dashed arrow r2′ schematically indicates the redirection of the second fuel from the second fuel injection hole h2 against the convex first portion 37 of the fuel impingement surface 35′″.

As seen in FIG. 9, the convex shape of the first portion 37 of the fuel impingement surface 35′″ illustrated in FIG. 9 causes the second fuel to be redirected to obtain more movement in radial directions relative to the cylinder axis ax2 of the cylinder than the redirections of the second fuel against the second portion 39 of the fuel impingement surface 35′″.

In this manner, the fuel impingement surface 35′″ according to the embodiments illustrated in FIG. 9 causes the second fuel to be redirected into various parts of the combustion chamber 4 in a more efficient manner which can cause early ignition of the first fuel as well as a distribution of the second fuel further radially into the combustion chamber 4 as is indicated in FIG. 9.

According to the embodiments illustrated in FIG. 3-FIG. 9, the fuel impingement surfaces 35, 35′, 35″, 35′″ are substantially smooth surfaces. However, according to further embodiments, one or more of these fuel impingement surfaces 35, 35′, 35″, 35′″ may be patterned. The pattern may comprise a number of protrusions protruding from the fuel impingement surface 35, 35′, 35″, 35′″ and/or a number of recesses provided in the fuel impingement surface 35, 35′, 35″, 35′″. According to some embodiments, the pattern of a fuel impingement surface 35, 35′, 35″, 35′″ comprises a number of protrusions and/or valleys extending radially across the fuel impingement surface 35, 35′, 35″, 35′″ in a direction from the center axis ax3 of the piston 5.

The feature “fuel stream formation” as referred to herein may also be referred to as a fuel spray, a fuel jet, or the like.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A fuel injector configured to inject a first and a second fuel into a combustion chamber of an internal combustion engine, wherein the second fuel is different from the first fuel, and wherein the fuel injector comprises a nozzle portion comprising:
a number of first fuel injection holes for injecting the first fuel into the combustion chamber, wherein the first fuel injection holes are circumferentially distributed on the nozzle portion around a center axis of the nozzle portion; and
a second fuel injection hole for injecting the second fuel into the combustion chamber,
wherein the second fuel injection hole is configured to inject the second fuel in a main fuel injection direction substantially coinciding with the center axis of the nozzle portion.

2. The fuel injector according to claim 1, wherein the second fuel injection hole is configured such that the angle between the main fuel injection direction of the second fuel and the center axis of the nozzle portion is one of: (i) less than 15 degrees or (ii) less than 10 degrees.

3. The fuel injector according to claim 1, wherein the center axis of the nozzle portion extends through at least a portion of the second fuel injection hole.

4. The fuel injector according to claim 1, wherein a geometrical center line of the second fuel injection hole is parallel to the center axis of the nozzle portion.

5. The fuel injector according to claim 1, wherein the fuel injector comprises one second fuel injection hole only.

6. The fuel injector according to claim 1, wherein the number of first fuel injection holes comprises at least three first fuel injection holes.

7. The fuel injector according to claim 1, wherein each first fuel injection hole of the number of first fuel injection holes is configured such that the angle between the main fuel injection direction of the first fuel and the center axis of the nozzle portion is one of: (i) greater than 30 degrees or (ii) greater than 50 degrees.

8. The fuel injector according to claim 1, wherein the fuel injector comprises a fuel injector body comprising:
a first fuel cavity configured to accommodate the first fuel; and
a second fuel cavity configured to accommodate the second fuel, and wherein the fuel injector comprises:
a first needle seat;
a first needle configured to interact with the first needle seat to open and close a fluid connection between the first fuel cavity and the number of first fuel injection holes;
a second needle seat; and
a second needle configured to interact with the second needle seat to open and close a fluid connection between the second fuel cavity and the second fuel injection hole.

9. The fuel injector according to claim 8, wherein at least part of the second needle is arranged inside the first needle.

10. The fuel injector according to claim 8, wherein at least part of the second fuel cavity is arranged inside the first needle.

11. The fuel injector according to claim 8, wherein the second fuel injection hole extends through a portion of the first needle.

12. The fuel injector according to claim 8, wherein the second needle seat is formed by an inner surface of the first needle

13. The fuel injector according to claim 8, wherein the first and second needles are configured to open and close the respective fluid connections by moving in directions parallel to the center axis of the nozzle portion.

14. An internal combustion engine comprising:
a cylinder;
a piston arranged in the cylinder and being arranged to reciprocate along a cylinder axis of the cylinder;
a combustion chamber formed between walls of the cylinder and a piston top of the piston; and
a fuel injector configured to inject a first fuel and a second fuel into the combustion chamber, wherein the second fuel is different from the first fuel, and wherein the fuel injector comprises a nozzle portion comprising:
a number of first fuel injection holes for injecting the first fuel into the combustion chamber, wherein the first fuel injection holes are circumferentially distributed on the nozzle portion around a center axis of the nozzle portion; and
a second fuel injection hole for injecting the second fuel into the combustion chamber,
wherein the second fuel injection hole is configured to inject the second fuel in a main fuel injection direction substantially coinciding with the center axis of the nozzle portion.

15. The internal combustion engine according to claim 14, wherein the angle between the main fuel injection direction of the second fuel and the cylinder axis of the cylinder is one of: (i) less than 15 degrees or (ii) less than 10 degrees.

16. The internal combustion engine according to claim 14, wherein the center axis of the nozzle portion is parallel to the cylinder axis of the cylinder.

17. The internal combustion engine according to claim 14, wherein the center axis of the nozzle portion coincides with the cylinder axis of the cylinder.

18. The internal combustion engine according to claim 14, wherein the piston top comprises a piston bowl and a protrusion protruding from a bottom surface of the piston bowl and wherein the protrusion comprises a fuel impingement surface facing the fuel injector.

19. The internal combustion engine according to claim 18, wherein the fuel impingement surface is substantially flat.

20. The internal combustion engine according to claim 18, wherein the fuel impingement surface is convex.

21. The internal combustion engine according to claim 18, wherein the fuel impingement surface is concave.

22. The internal combustion engine according to claim 18, wherein the fuel impingement surface comprises a first portion located at a radial center of the fuel impingement surface and a second portion surrounding the first portion and wherein the first portion is convex and the second portion is concave.

23. The internal combustion engine according to claim 18, wherein the fuel impingement surface is patterned.

24. The internal combustion engine according to claim 18, wherein the internal combustion engine is a compression ignition engine.

25. The internal combustion engine according to claim 14, wherein the first fuel has a higher research octane number than the second fuel.

26. The internal combustion engine according to claim 14, wherein the first fuel has a research octane number above 50, and wherein the second fuel has a research octane number below 50.

27. The internal combustion engine according to claim 14, wherein the first fuel is a gaseous fuel, and wherein the second fuel is a liquid fuel.

28. The internal combustion engine according to claim 14, wherein the first fuel comprises hydrogen gas and/or natural gas, and wherein the second fuel comprises diesel and/or a diesel-like fuel.

29. A vehicle comprising an internal combustion engine, said internal combustion engine comprising:
a cylinder;
a piston arranged in the cylinder and being arranged to reciprocate along a cylinder axis of the cylinder;
a combustion chamber formed between walls of the cylinder and a piston top of the piston; and
a fuel injector configured to inject a first fuel and a second fuel into the combustion chamber, wherein the second fuel is different from the first fuel, and wherein the fuel injector comprises a nozzle portion comprising:
a number of first fuel injection holes for injecting the first fuel into the combustion chamber, wherein the first fuel injection holes are circumferentially distributed on the nozzle portion around a center axis of the nozzle portion; and
a second fuel injection hole for injecting the second fuel into the combustion chamber,
wherein the second fuel injection hole is configured to inject the second fuel in a main fuel injection direction substantially coinciding with the center axis of the nozzle portion.
